(19) United States
(12) Patent Application Publication
(10) Pub. No.: US 2013/0035095 A1
(43) Pub. Date: Feb. 7, 2013

(54) APPARATUSES AND METHODS FOR ROAMING PUBLIC LAND MOBILE NETWORK (PLMN) SELECTION

(71) Applicants: Yun-Wen Wang, Taipei City (TW); Chin-Han Wang, Taipei City (TW); Ting-Yu Wang, Zhonghe City (TW)

(72) Inventors: Yun-Wen Wang, Taipei City (TW); Chin-Han Wang, Taipei City (TW); Ting-Yu Wang, Zhonghe City (TW)

(73) Assignee: MEDIATEK INC., Hsin-Chu (TW)

(21) Appl. No.: 13/195,416

(22) Filed: Aug. 1, 2011

(51) Int. Cl. H04W 8/02; H04W 4/12; H04W 60/00

(52) U.S. Cl. 455/433; 455/435.1

(57) ABSTRACT

A mobile communications device accompanying with a radio frequency (RF) unit is provided for roaming Public Land Mobile Network (PLMN) selection. In the mobile communications device, a processing unit directs the RF unit to register to a plurality of PLMNs one at a time for reception of at least one Short Message Service (SMS) text message from the currently registered PLMN, and then retrieves service charging information from the SMS text message for each of the PLMNs. Also, the processing unit directs the RF unit to register to one of the PLMNs for obtaining mobile services therefrom according to the service charging information.

### BACKGROUND OF THE INVENTION

1. Field of the Invention

The invention generally relates to the Public Land Mobile Network (PLMN) selection, and more particularly, to the roaming PLMN selection in which charging rates are taken into account.

2. Description of the Related Art

With growing demand for ubiquitous computing and networking, there are a number of Public Land Mobile Networks (PLMNs) in a country or in a specific region of a country, which are deployed by different operators to provide alternatives for users to obtain mobile services, such as Short Message Service (SMS), voice service, and data service, etc., therefrom. For a User Equipment (UE) subscribing mobile services of a particular PLMN, which may be referred to as Home PLMN (HPLMN) herein, there may be a situation where the UE moves into a region without the mobile services of the HPLMN. For example, the user of the UE may move from one country to another, or from one state to another, for travel or business purposes. In this situation, the UE may have to “roam” to one of the detected PLMNs, i.e., the UE may select one of the PLMNs which provide mobile services in the current location of the UE.

Generally, when roaming, the UE may select from the Roaming PLMNs (RPLMNs) which are in collaboration with the HPLMN. However, it is noted that the service charging rates may vary from one PLMN to another. Particularly, the RPLMN which is in collaboration with the HPLMN may not have the most economical service charging rate for the user, since user behaviors concerning the type of used mobile services are different. For example, if a user uses a great deal of voice services and few SMS and data services in a monthly average, then an RPLMN with a higher charging rate for voice service and lower charging rate for data service, is not an economical choice for the user. Therefore, it is desirable to have an efficient and economical way of selecting RPLMN when roaming

### BRIEF SUMMARY OF THE INVENTION

Accordingly, embodiments of the invention provide apparatuses and methods for roaming Public Land Mobile Network (PLMN) selection. In one aspect of the invention, a mobile communications device accompanying with a radio frequency (RF) unit and comprising a processing unit is provided. The processing unit directs the RF unit to register to a plurality of PLMNs one at a time for reception of at least one Short Message Service (SMS) text message from the currently registered PLMN, and retrieves service charging information from the SMS text message for each of the PLMNs. Also, the processing unit directs the RF unit to register to one of the PLMNs for obtaining mobile services therefrom according to the service charging information.

In another aspect of the invention, a method for roaming PLMN selection by a mobile communications device is provided. The method comprises the steps of registering to a plurality of PLMNs one at a time for reception of at least one SMS text message from the currently registered PLMN, retrieving service charging information from the SMS text message for each of the PLMNs, and registering to one of the PLMNs for obtaining mobile services therefrom according to the service charging information.

Other aspects and features of the present invention will become apparent to those with ordinarily skill in the art upon review of the following descriptions of specific embodiments of the apparatuses and methods for roaming PLMN selection.

### BRIEF DESCRIPTION OF DRAWINGS

The invention can be more fully understood by reading the subsequent detailed description and examples with references made to the accompanying drawings, wherein:

FIG. 1 is a block diagram of a wireless communications environment according to an embodiment of the invention;

FIG. 2 is a block diagram illustrating the hardware architecture of the mobile communication device 110 according to an embodiment of the invention;

FIG. 3 is a message sequence chart illustrating a roaming PLMN selection procedure according to an embodiment of the invention; and

FIG. 4 is a flow chart illustrating an embodiment of the method for roaming PLMN selection.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof

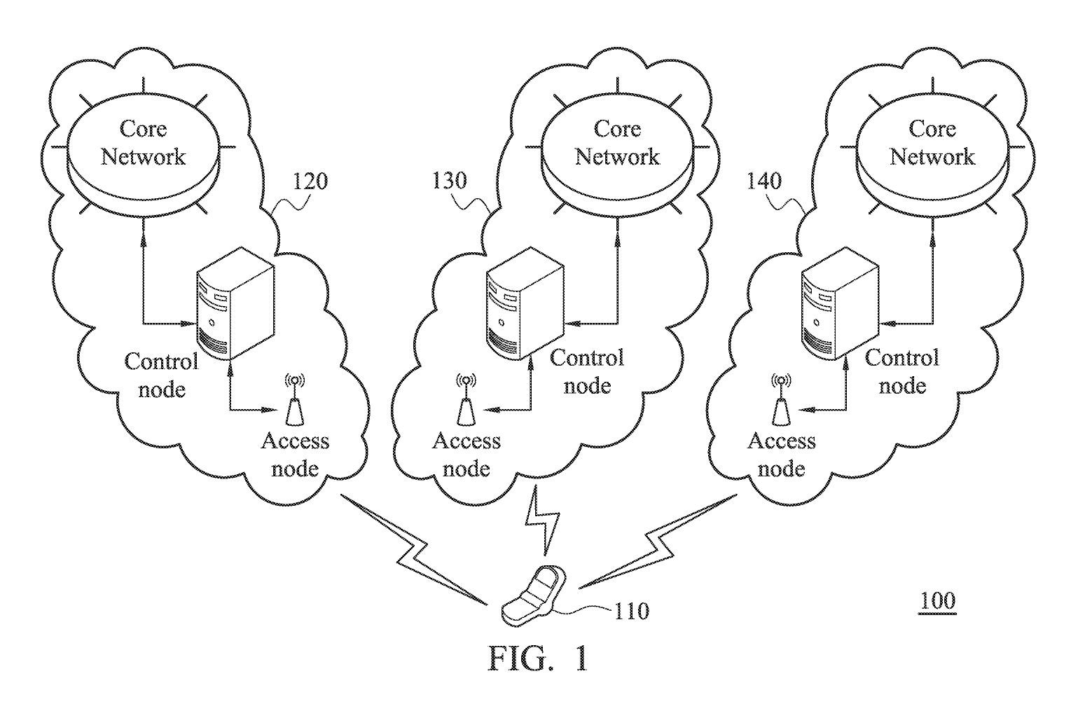

FIG. 1 is a block diagram of a wireless communications environment according to an embodiment of the invention. The wireless communications environment 100 comprises a mobile communication device 110, and service networks 120, 130, and 140. Specifically, the service networks 120, 130, and 140 are not the Home Public Land Mobile Network (HPLMN) which the mobile communication device 110 subscribes mobile services from. The mobile communication device 110 may roam to one of the service networks 120, 130, and 140 for obtaining mobile services, such as Short Message Service (SMS), voice service, and data services (including e-mail transmission, Web browsing, file upload/download, instant messaging, streaming video, voice over IP (VOIP) or others. In one embodiment, the user may turn off the mobile communication device 110 when traveling overseas by airplane, and turn on the mobile communication device 110 when arriving in another country where only the service networks 120, 130, and 140, instead of the HPLMN, are available. Each of the service networks 120, 130, and 140 comprises at least one access node for performing wireless transmissions and receptions to and from the mobile communication device 110, and a control node for controlling the operation of the at least one access node, wherein the control node is further connected to a core network. The access node may be a base transceiver station (BTS), a node-B, a Base Station (BS) or others, and the control node may be a Base Station Controller (BSC), a Radio Network Controller (RNC) or others, depending on the utilized Radio Access Technology (RAT). The service networks 120, 130, and 140 may be in compliance with any three of the Global System for Mobile communications (GSM) technology, General Packet Radio Service (GPRS) technology, Enhanced Data rates for Global Evolution (EDGE) technology, Wideband Code Division Multiple Access (WCDMA) technology, Code Division Multiple Access 2000 (CDMA-2000) technology, Time Division-Synchronous Code Division Multiple Access (TD-SCDMA) technology, Worldwide Interoperability for Microwave Access (WiMAX) technology, and Long Term Evolution (LTE) technology, etc.

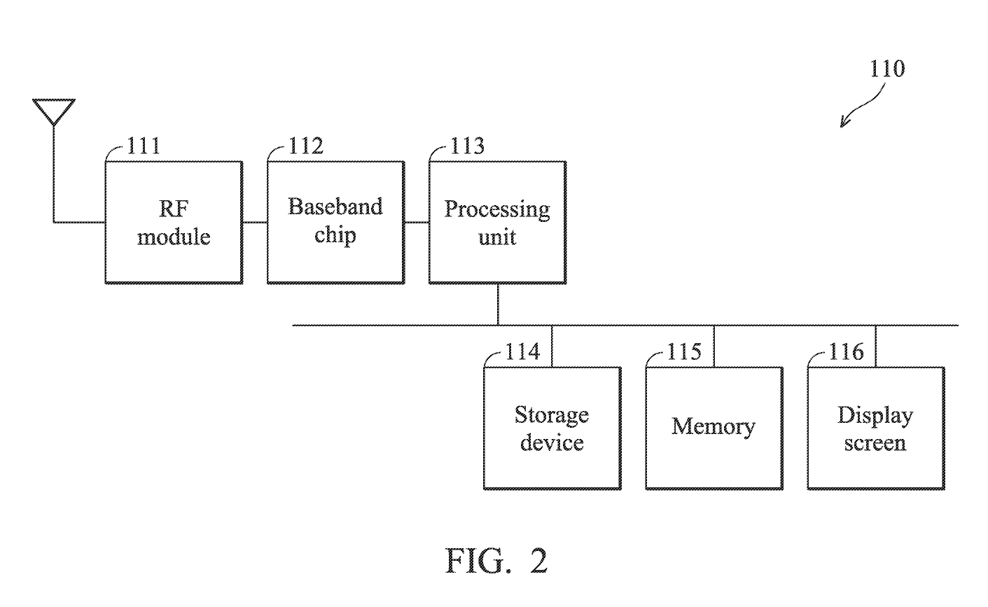

FIG. 2 is a block diagram illustrating the hardware architecture of the mobile communication device 110 according to an embodiment of the invention. The mobile communication device 110 is equipped or accompanied with a Radio Frequency (RF) unit 111 and a Baseband chip 112 to communicate with a corresponding node via a cellular network. The Baseband chip 112 may contain multiple hardware devices to perform baseband signal processing, including analog to digital conversion (ADC)/digital to analog conversion (DAC), gain adjusting, modulation/demodulation, encoding/decoding, and so on. The RF unit 111 may receive RF wireless signals, convert the received RF wireless signals to baseband signals, which are processed by the Baseband chip 112, or receive baseband signals from the Baseband chip 112 and convert the received baseband signals to RF wireless signals, which are later transmitted. The RF unit 111 may also contain multiple hardware devices to perform radio frequency conversion. For example, the RF unit 111 may comprise a mixer to multiply the baseband signals with a carrier oscillated in the radio frequency of the wireless communications system, wherein the radio frequency may be 900 MHz, 1800 MHz or 1900 MHz utilized in GSM systems, or may be 900 MHz, 1900 MHz or 2100 MHz utilized in WCDMA systems, or others depending on the radio access technology (RAT) in use. In another embodiment, the RF unit 111 and the Baseband chip 112 may be incorporated into one single component for carrying both the baseband signal processing and the RF wireless signal processing. The mobile communication device 110 is further equipped with a display screen 116 as part of a man-machine interface (MMI). The MMI is the means by which people interact with the mobile communication device 110. The MMI may contain screen menus, icons, text messages, and so on, as well as physical buttons, a keypad and the display screen 116, and so on. A processing unit 113 of the mobile communication device 110, such as a general-purposed processor or a micro-control unit (MCU), or others, loads and executes a series of program codes from a memory 115 or a storage device 114 to provide the function of roaming PLMN selection in this invention.

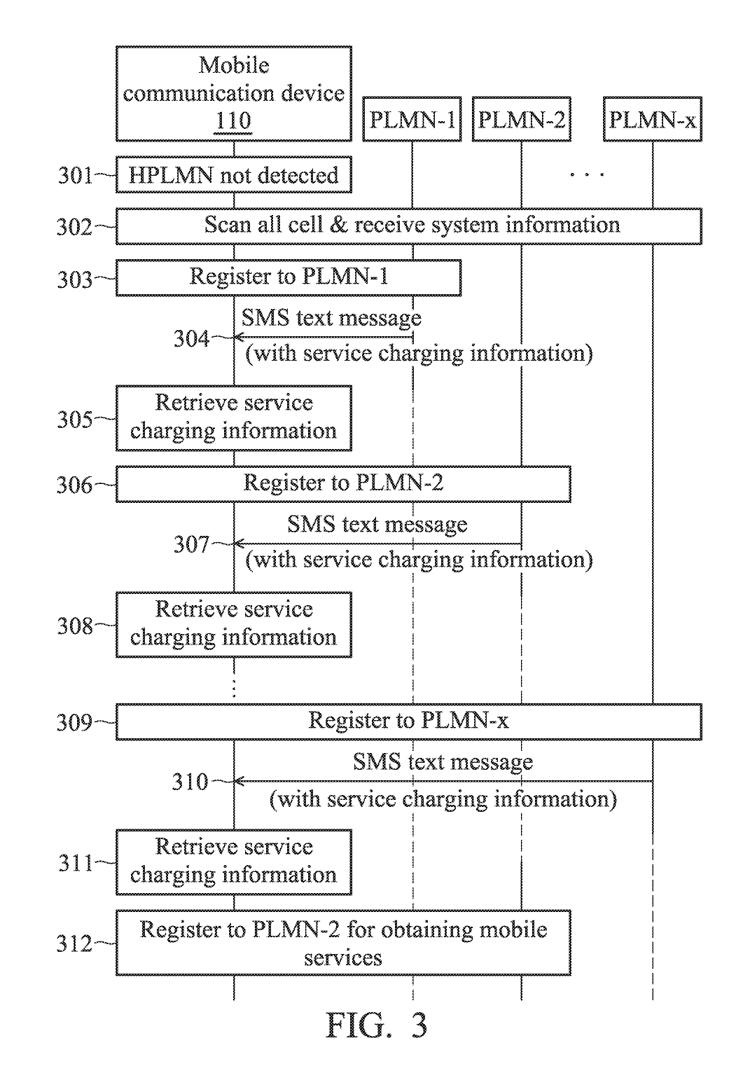

FIG. 3 is a message sequence chart illustrating a roaming PLMN selection procedure according to an embodiment of the invention. Taking the mobile communication device 110 for example, the roaming PLMN selection procedure is initiated when the processing unit 113 determines that the HPLMN is not detected via the RF unit 111 (step S301). In another embodiment, the roaming PLMN selection procedure may be initiated by a user request to select a PLMN with the most economical service charging rate for the user. Without the HPLMN being available, the mobile communication device 110 needs to roam to one of the available PLMNs in its current location. To further clarify, the mobile communication device 110 collects available PLMNs (denoted as PLMN-1 to PLMN-x) in its current location (step S302). Specifically, the processing unit 113 may direct the RF unit 111 to perform an initial cell search for detecting signal strengths from all cells in the current location and receiving system information of the detected cells. From the system information, the identity of the PLMN to which the detected cell belongs may be obtained. For example, if a PLMN is a GSM system, the cells of the GSM system may each broadcast System Information 3 (SI-3) which indicates the identity of the PLMN. If a PLMN is a WCDMA system, the cells of the WCDMA system may each broadcast System Information Block 1 (SIB-1) which indicates the identity of the PLMN. After collecting available PLMNs in the current location, the mobile communication device 110 registers to the collected PLMNs one at a time. Specifically, the mobile communication device 110 first registers to the PLMN-1 (step S303). After successful registration to the PLMN-1, the mobile communication device 110 receives SMS text message(s) from the PLMN-1 (step S304), and then retrieves the service charging information from the received SMS text message(s) (step S305). Note that, before registration to the collected PLMNs, the mobile communication device 110 may first sort the collected PLMNs according to the detected signal strengths, e.g., the detected power level, in a descending order, and then select one PLMN for registration from the collected PLMNs by the descending order. That is, the PLMN with higher signal strength may be selected before the PLMN with lower signal strength. Alternatively, the mobile communication device 110 may randomize the order of collected PLMNs with detected signal strengths which are greater than or equal to a threshold value, and only sort the collected PLMNs with detected signal strengths which are lower than the threshold value in the descending order. Furthermore, the mobile communication device 110 may sort the collected PLMNs according to a preferred PLMN list in a descending order, wherein the preferred PLMN list refers to a PLMN list stored in a subscriber identity card, which includes one or more PLMN IDs preferable to the HPLMN; or the mobile communication device 110 may sort the collected PLMNs according to the previous selection result, wherein the previous selection result refers to the order of selected PLMNs for registration during the last time the roaming PLMN selection procedure was performed.

Generally, the SMS text message received from the PLMN-1 is mainly used to welcome the user and also indicate the service charging information of the PLMN-1. An exemplary welcome SMS text message is as follows in Table 1:

TABLE 1

Welcome to tele.ring! To call Singapore, dial +65phone no. Voice
@$5/min. SMS S$0.60/sms. Data S$20/MB.

The service charging information may comprise the charging rates for different services, including voice service, SMS, and data service, etc. Accordingly, in step S305, a table for recording the service charging rates of the PLMN-1 may be generated, and an example of such a table for the SMS text message in Table 1 is given below.

TABLE 2

| Type of Service | Price | Unit |
|---|---|---|
| SMS | $0.60 | sms |
| Voice | $5 | min |
| Data | $20 | MB |

In another embodiment, after the mobile communication device 110 is successfully registered to the PLMN-1, the PLMN-1 may transmit a first SMS text message to welcome the user and then transmit a second SMS text message to indicate the service charging information. Accordingly, the mobile communication device 110 may determine a first period of time for controlling the waiting of receiving the first SMS text message from the PLMN-1. If the first SMS text message is received before the first period of time has passed, the mobile communication device 110 may further determine whether the first SMS text message indicates the service charging information. If so, step S305 is performed. If the first SMS text message does not indicate the service charging information, or if the first period of time has passed and no SMS text message is received, then the mobile communication device 110 may continue to wait for the second SMS text message from the PLMN-1. Similarly, the mobile communication device 110 may determine a second period of time for controlling the waiting of receiving the second SMS text message. For example, the first period of time may be configured to be 1 minute long, and the second period of time may be configured to be 0.5 minutes long. If the second SMS text message is received before the second period of time has passed, the mobile communication device 110 may further determine whether the second SMS text message indicates the service charging information. If so, step S305 is performed, and if not, the roaming PLMN selection procedure continues for the mobile communication device 110 to register to the PLMN-2 (step S306). After successful registration to the PLMN-2, the mobile communication device 110 receives SMS text message(s) from the PLMN-2 (step S307), and then retrieves the service charging information from the received SMS text message(s) (step S308).

In steps S305, S308, and S311, the mobile communication device 110 may retrieve the service charging information by inputting the received SMS text message(s) into a predetermined parser in compliance with the language of the received SMS text message(s). The predetermined parser may employ the Recursive-Descent Parsing rule, or Bottom-Up Parsing rule or any other known parsing rule, for analyzing the lexeme, syntax, and semantics of the received SMS text message. In addition, the mobile communication device 110 may further display the retrieved service charging information to the user, so that the user may confirm whether the service charging information is correctly retrieved by the parser. If the service charging information is not correctly retrieved by the parser, the mobile communication device 110 may display the received SMS text message(s) and prompt the user to help determine the correct charging rate for each type of mobile services. Taking the SMS text message in Table 1 for example, initially, the first parsed character string “Welcome” is highlighted, and then the user may determine the correct charging rate for SMS by moving the highlight to the parsed character string corresponding to the charging rate for SMS, i.e., “S$0.60/sms”. The correct charging rates for voice and data services may be determined in a similar way.

Subsequent to step S308, the roaming PLMN selection procedure continues for the mobile communication device 110 to register to the rest of the collected PLMNs. In this embodiment, since there are x PLMNs collected in step S302, the mobile communication device 110 last registers to the PLMN-x in sequence (step S309). After successful registration to the PLMN-x, the mobile communication device 110 receives SMS text message(s) from the PLMN-x (step S310), and then retrieves the service charging information from the received SMS text message(s) (step S311). After the service charging information of all collected PLMNs has been obtained, the mobile communication device 110 selects the PLMN-2 among all collected PLMNs according to the retrieved service charging information and registers to the PLMN-2 for obtaining mobile services therefrom (step S312), to end the roaming PLMN selection procedure. Specifically, the PLMN-2 should have the most economical service charging rate for the user. In one embodiment, the mobile communication device 110 may first record user behavior patterns concerning the type of used mobile services during a past period of time, e.g., a week or a month. For example, the user behavior pattern may indicate the total number of SMS text messages sent during the past month, the total chargeable duration of all voice calls during the past month, and the total amount of data transmitted/received via data services during the past month. Next, the mobile communication device 110 may calculate the expected bills by applying the service charging rates of different PLMNs to the recorded user behavior pattern, respectively. Accordingly, the mobile communication device 110 may further select the one with the lowest fee among the expected bills. In another embodiment, the mobile communication device 110 may first determine a set of weightings (x, y, z) for user behavior patterns concerning the type of used mobile services during a past period of time, e.g., a week or a month, wherein x, y, and z represent weightings of the SMS, voice service, and data service used by the user, respectively, and a higher weighting value indicates a corresponding type of mobile service being used more frequently than other types of mobile services. For example, the weightings for the user who make a lot of voice calls, and few SMS and data services may be (0.8, 0.1, 0.1). Next, the mobile communication device 110 may calculate the expected bills by applying the service charging rates of different PLMNs to the recorded user behavior pattern, respectively, and further select the one with the lowest sum among all calculated results.

In another embodiment, for step S312, the mobile communication device 110 may simply display the retrieved service charging information on the display screen 116 for the user to manually select one of the collected PLMNs which has the most economical service charging rate. In yet another embodiment, in order to save system resources consumed for parsing the SMS text messages and to avoid parsing error, the steps S305, S308, and S311 may be omitted, and the mobile communication device 110 may simply display the SMS text messages received from the collected PLMNs for the user to manually select one of the collected PLMNs which has the most economical service charging rate for the user, instead of automatically selecting one of the collected PLMNs.

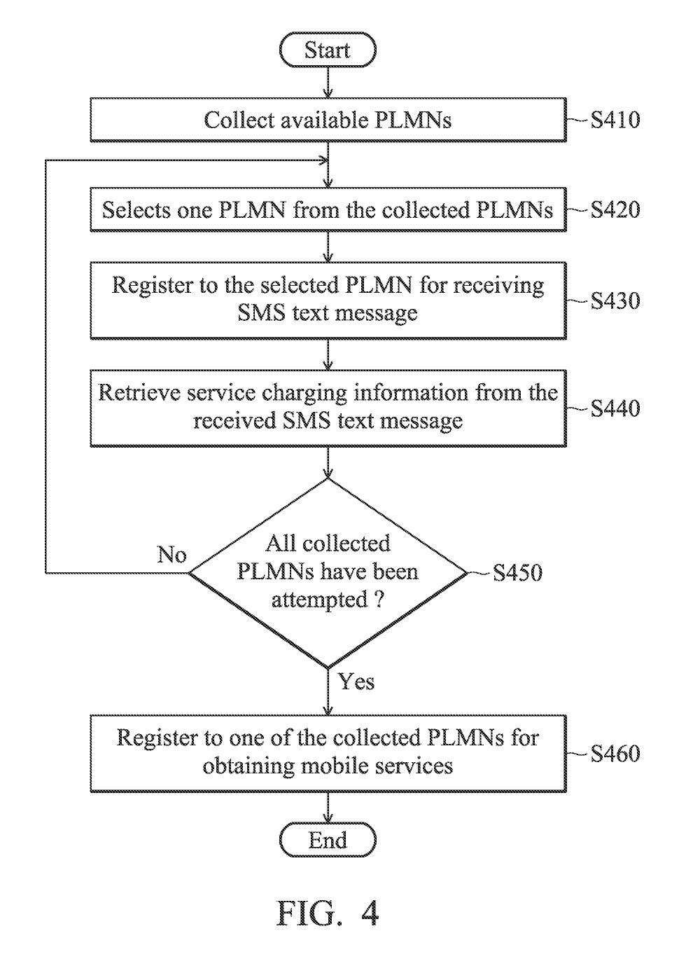

FIG. 4 is a flow chart illustrating an embodiment of the method for roaming PLMN selection. The method may be applied in any mobile communication device for a roaming situation. Taking the mobile communication device 110 for example, the processing unit 113 may determine whether the HPLMN is detected via the RF unit 111, and if not, the mobile communication device 110 needs to roam to one of the available PLMNs in its current location. Also, the method may be applied by a user request to select a PLMN with the most economical service charging rate for the user. To begin the method, the mobile communication device 110 first collects available PLMNs in its current location (step S410). Specifically, the mobile communication device 110 may perform an initial cell search for detecting signal strengths from all cells in the current location and receiving system information of the detected cells. From the system information, the identity of the PLMN to which the detected cell belongs may be obtained. After collecting available PLMNs in its current location, the mobile communication device 110 selects one PLMN from the collected PLMNs according to a particular selection rule (step S420). In one embodiment, the mobile communication device 110 may first sort the collected PLMNs according to the detected signal strengths, e.g., the detected power level, in a descending order, and then select the PLMN for registration from the collected PLMNs by the descending order. Alternatively, the mobile communication device 110 may randomize the order of the collected PLMNs with detected signal strengths which are greater than or equal to a threshold value, and only sort the collected PLMNs with detected signal strengths which are lower than the threshold value in the descending order. In another embodiment, the mobile communication device 110 may sort the collected PLMNs according to a preferred PLMN list in a descending order, wherein the preferred PLMN list refers to a PLMN list stored in a subscriber identity card, which includes one or more PLMN IDs preferable to the HPLMN. In yet another embodiment, the mobile communication device 110 may sort the collected PLMNs according to the previous selection result, wherein the previous selection result refers to the order of selected PLMNs for registration in the last appliance of the method.

Subsequent to step S420, the mobile communication device 110 registers to the selected PLMN for receiving SMS text message(s) therefrom (step S430). Specifically, the mobile communication device 110 may first perform a registration procedure to register to the selected PLMN, and after successful registration, wait for receiving SMS text message(s) from the currently registered PLMN. When receiving SMS text message(s), the mobile communication device 110 retrieves the service charging information from the received SMS text message(s) (step S440), and then determines whether registrations to all collected PLMNs have been attempted for obtaining the service charging information thereof (step S450). If not, the mobile communication device 110 repeats steps S420 to S440 until registrations to all collected PLMNs have been attempted for obtaining the service charging information thereof In step 430, generally, after the mobile communication device 110 has successfully registered to a PLMN, the PLMN may transmit an SMS text message which is mainly used to welcome the user and also indicate the service charging information. The mobile communication device 110 may further determine a period of time for controlling the waiting of receiving the SMS text message from the currently registered PLMN. If no SMS text message is received before the period of time has passed, step S440 may be skipped and step S450 may be performed. Alternatively, after the mobile communication device 110 has successfully registered to a PLMN, the PLMN may transmit a first SMS text message to welcome the user and then transmit a second SMS text message to indicate the service charging information. Accordingly, the mobile communication device 110 may determine a first period of time for controlling the waiting of receiving the first SMS text message from the currently registered PLMN. If the first SMS text message is received before the first period of time has passed, the mobile communication device 110 may further determine whether the first SMS text message indicates the service charging information. If so, step S440. If the first SMS text message does not indicate the service charging information, or if the first period of time has passed and no SMS text message is received, then the mobile communication device 110 may continue to wait for a second SMS text message from the currently registered PLMN. Similarly, the mobile communication device 110 may determine a second period of time for controlling the waiting of receiving the second SMS text message. If the second SMS text message is received before the second period of time has passed, the mobile communication device 110 may further determine whether the second SMS text message indicates the service charging information. If so, step S440 may be performed, and if not, step S440 may be skipped and step S450 may be performed.

In step S440, the mobile communication device 110 may retrieve the service charging information by inputting the received SMS text message into a predetermined parser in compliance with the language of the received SMS text message. In addition, the mobile communication device 110 may further display the retrieved service charging information to the user, so that the user may confirm whether the service charging information is correctly retrieved by the parser. If the service charging information is not correctly retrieved by the parser, the mobile communication device 110 may display the received SMS text message and prompt the user to help determine the correct charging rate for each type of mobile services.

Subsequent to step S450, after registrations to all collected PLMNs have been attempted, the mobile communication device 110 selects one of the collected PLMNs according to the retrieved service charging information of all collected PLMNs and registers to the selected PLMN for obtaining mobile services therefrom (step S460), ending the method. Specifically, the selected PLMN should have the most economical service charging rate for the user. In one embodiment, the mobile communication device 110 may first record user behavior patterns concerning the type of used mobile services during a past period of time, e.g., a week or a month, and then calculate the expected bills by applying the service charging rates of different PLMNs to the recorded user behavior pattern, respectively. Next, the mobile communication device 110 may select the one with the lowest fee among the expected bills. In another embodiment, the mobile communication device 110 may first determine a set of weightings (x, y, z) for user behavior patterns concerning the type of used mobile services during a past period of time, e.g., a week or a month, wherein x, y, and z represent weightings of the SMS, voice service, and data service used by the user, respectively, and a higher weighting value indicates a corresponding type of mobile service being used more frequently than other types of mobile services. Next, the mobile communication device 110 may calculate the expected bills by applying the service charging rates of different PLMNs to the recorded user behavior pattern, respectively, and further select the one with the lowest sum among all calculated results.

In another embodiment, for step S460, the mobile communication device 110 may simply display the retrieved service charging information on the display screen 116 for the user to manually select one of the collected PLMNs which has the most economical service charging rate. In yet another embodiment, in order to save system resources consumed for parsing the SMS text messages and to avoid parsing error, the step S440 may be omitted, and the mobile communication device 110 may simply display the SMS text messages received from the collected PLMNs for the user to manually select one of the collected PLMNs which has the most economical service charging rate for the user, instead of automatically selecting one of the collected PLMNs.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A mobile communications device accompanying with a radio frequency (RF) unit, comprising:
a processing unit directing the RF unit to register to a plurality of Public Land Mobile Networks (PLMNs) one at a time for reception of at least one Short Message Service (SMS) text message from the currently registered PLMN, retrieving service charging information from the SMS text message for each of the PLMNs, and directing the RF unit to register to one of the PLMNs for obtaining mobile services therefrom according to the service charging information.

2. The mobile communications device of claim 1, wherein the processing unit further determines whether a Home PLMN (HPLMN) is detected via the RF unit, and the steps of registering to the PLMNs, retrieving service charging information, and registering to the one of the PLMNs are performed in response to the HPLMN not being detected.

3. The mobile communications device of claim 1, wherein the steps of registering to the PLMNs, retrieving service charging information, and registering to the one of the PLMNs are triggered by a user command.

4. The mobile communications device of claim 1, wherein the processing unit further directing the RF unit to perform an initial cell search for detecting signal strengths from the PLMNs and receiving system information concerning the PLMNs, prior to registering to the PLMNs.

5. The mobile communications device of claim 4, wherein the processing unit further sorts the PLMNs according to the detected signal strengths in a descending order, and the registering to the PLMNs one at a time is performed according to the descending order.

6. The mobile communications device of claim 1, wherein the processing unit further sorts the PLMNs according to a previous selection result order for registering of the PLMNs, and the step of registering to the PLMNs one at a time is performed according to the previous selection result.

7. The mobile communications device of claim 1, wherein the processing unit further determines whether the received SMS text message comprises service charging information for each of the PLMNs, and directing the RF unit to continue the waiting for reception of another SMS text message from the currently registered PLMN before registering to the next PLMN, in response to the received SMS text message not comprising service charging information.

8. The mobile communications device of claim 1, wherein the one of the PLMNs has a lowest service charging rate among the PLMNs.

9. The mobile communications device of claim 1, wherein the processing unit further determines whether the service charging information is confirmed or denied by a user, prior to registering to the one of the PLMNs, and the step of registering to the one of the PLMNs is performed in response to the service charging information being confirmed by the user.

10. The mobile communications device of claim 9, wherein the received SMS text message is displayed to the user, in response to the service charging information being denied by the user, and the one of the PLMNs is selected by the user according to the received SMS text message for the RF unit to register to.

11. A method for roaming Public Land Mobile Network (PLMN) selection by a mobile communications device, comprising:
registering to a plurality of PLMNs one at a time for reception of at least one Short Message Service (SMS) text message from the currently registered PLMN;
retrieving service charging information from the SMS text message for each of the PLMNs; and
registering to one of the PLMNs for obtaining mobile services therefrom according to the service charging information.

12. The method of claim 11, further comprising determining whether a Home PLMN (HPLMN) is detected, wherein the steps of registering to the PLMNs, retrieving service charging information, and registering to the one of the PLMNs are performed in response to the HPLMN not being detected.

13. The method of claim 11, wherein the steps of registering to the PLMNs, retrieving service charging information, and registering to the one of the PLMNs are triggered by a user command.

14. The method of claim 11, further comprising performing an initial cell search for detecting signal strengths from the PLMNs and receiving system information concerning the PLMNs, prior to registering to the PLMNs.

15. The method of claim 14, further comprising sorting the PLMNs according to the detected signal strengths in a descending order, wherein the step of registering to the PLMNs one at a time is performed according to the descending order.

16. The method of claim 11, further comprising sorting the PLMNs according to a last selection result order for registering of the PLMNs, and the step of registering to the PLMNs one at a time is performed according to the last selection result.

17. The method of claim 11, further comprising determining whether the received SMS text message comprises the service charging information for each of the PLMNs, and continuing to wait for reception of another SMS text message from the currently registered PLMN before registering to the next PLMN, in response to the received SMS text message not comprising service charging information.

18. The method of claim 11, wherein the one of the PLMNs has a lowest service charging rate among the PLMNs.

19. The method of claim 11, further comprising determining whether the service charging information is confirmed or denied by a user, prior to registering to the one of the PLMNs, wherein the step of registering to the one of the PLMNs is performed in response to the service charging information being confirmed by the user.

20. The method of claim 19, further comprising displaying the received SMS text message to the user, in response to the service charging information being denied by the user, wherein the one of the PLMNs is selected by the user according to the received SMS text message for the mobile communications device to register to.
